(19) United States
(12) Patent Application Publication
(10) Pub. No.: US 2009/0096118 A1
(43) Pub. Date: Apr. 16, 2009

(54) Portable heater and humidifier apparatus

(76) Inventors: Carl Brown, Tokyo (JP); Akio Goto, Tokyo (JP)

Correspondence Address: STETINA BRUNDA GARRED & BRUCKER, 75 ENTERPRISE, SUITE 250, ALISO VIEJO, CA, 92656, US

(21) Appl. No.: 12/176,636

(22) Filed: Jul. 21, 2008

Related U.S. Application Data
(63) Continuation-in-part of application No. 12/014,427, filed on Jan. 15, 2008.

(30) Foreign Application Priority Data
Oct. 15, 2007 (JP) 2007-268034

(51) Int. Cl. B01F 3/04; F24F 6/00

(52) U.S. Cl. 261/128; 261/142

(57) ABSTRACT

A portable heater and humidifier apparatus is provided. The apparatus includes a housing with an inlet for receiving air from an area exterior to the housing. The housing includes an air passage disposed therein with a ceramic heating element located inside the air passage. The air passage includes a partition stationed between the ceramic heating element and a heater outlet that is used to exhaust heated air. A fan within the housing is used to direct air from outside of the housing into the air passage. The fan then directs the air through the ceramic heating element. A portion of the heated air continues to flow within the air passage until the heated air is exhausted from a heater outlet. The remaining heated air is diverted to a humidifier through an aperture located within the air passage. The heated air is then combined with fine water droplets generated by the humidifier to emit water vapor or mist from a humidifier outlet.

### CROSS-REFERENCE TO RELATED APPLICATIONS

The present application is a continuation-in-part of U.S. patent application Ser. No. 12/014,427 filed Jan. 15, 2008, the disclosure of which is incorporated herein by reference. U.S. patent application Ser. No. 12/014,427 claims priority to Japanese application no. 2007-268034 filed Oct. 15, 2007 entitled A Hot-Air Type Heater Apparatus.

### STATEMENT RE: FEDERALLY SPONSORED RESEARCH/DEVELOPMENT

Not Applicable

### BACKGROUND

1. Technical Field

The present invention relates to an improved heater and humidifier apparatus and, more particularly, to a hot-air type space heater and humidifier apparatus that utilizes a positive temperature coefficient (PTC) ceramic heating element as a heat source having adjacent heating and humidifying outlets.

2. Related Art

Space heaters are relatively small heaters that are portable or wall-mounted. Space heaters may use natural gas, propane, or electricity. Propane space heaters are generally one of two types, radiant (infrared) or circulation-type space heaters. Infrared propane space heaters function to heat objects which in turn heat the surrounding air whereas circulation type space heaters heat the air directly using a fan or convection. Additionally, propane space heaters are either vented or un-vented. Un-vented space heaters are low capacity heaters used to heat living areas but are not allowed in bedrooms, bathrooms, or confined spaces due to their fire hazards and the possible accumulation of gases at high levels. Kerosene heaters were once common, but may easily cause a fire, and must be completely cooled before being refueled.

A conventional hot-air type space heater uses, for example, a combustion method in which the air needed for combustion is taken from outside of the area to be heated. The air drawn from outside is then combusted in an enclosed combustion area. As a result, vapor and combustion exhaust are emitted outside the area to be heated, while the heater directs only warm air into the area to be heated. Another well known heater in the art is a petroleum oil fan heater. The oil fan heater intakes air from inside of an area to be heated. The air is then heated within the heater by combusting petroleum oil. The warm air is then returned to the area to be heated. However, because air needed for combustion is taken from outside the area to be heated, the air intake and vapor/combustion exhaust outlet are required to be located outside the area to be heated. Thus, the air intake and vapor/combustion exhaust outlet must be built on an outside wall of the structure, home or area that is to be heated. Therefore, the hot-air type space heater apparatus must be placed alongside the outside wall as well. The installation and operation may prove problematic, as additional piping and other fittings may be required. Piping heated air may increase the risk of leaks and/or malfunctions. Additionally, the operational cost of the hot-air type space heater apparatus is increased when installed outside of the area to be heated.

The most common of these space heaters is the electric heater because they are safer then natural gas and propane heaters. The danger of carbon monoxide poisoning related to electric heaters is minimized and in many cases eliminated. Additionally, electric heaters are typically less expensive to purchase. However, electric heaters are often more expensive to operate, because electricity is typically more expensive per unit of heat energy produced than gas or propane. Modern electric space heaters usually have ceramic heating elements rather than nichrome wires, and are fan-forced with a blower or squirrel-cage fan. The use of ceramic heating elements as opposed to nichrome wires is preferred because of the even distribution of heat as a result of using a ceramic heating element. The use of a ceramic heating element may also reduce or prevent thermal conduction of the housing or outer plate. This allows for the heaters to be encased in plastic, wood, or another material while nearly eliminating the risk associated with burns or fire hazards.

There are a few well known heaters with humidifiers in the art. A cool mist humidifier is one type of humidifier that may be combined with a heater apparatus. The cool mist humidifier may use a rotating disc that flings water at a diffuser. The diffuser is used to break the water into fine droplets that float into the air. Cool mist humidifiers do not selectively put water in the air. Further, such humidifiers add any suspended material in the water to the air such as microorganisms and minerals. The amount of minerals and other materials can be greatly reduced by using distilled water, though no water is absolutely pure. Depending on the volume, this dust may have negative health effects. To minimize the possible adverse health effects, a warm mist humidifier may be used. A warm mist humidifier boils water, releasing steam and moisture into the air. The steam that is released is sterile and free from minerals. However, the energy required to boil the water is more than the energy required for a cool mist humidifier. Therefore, the ability to reduce or minimize the minerals in the water using a cool mist humidifier together with a ceramic heater while achieving energy savings is desirable.

Accordingly, there exists a need in the art for an improved heater and humidifier apparatus which addresses one or more of the above or related deficiencies.

### BRIEF SUMMARY

A portable heater and humidifier apparatus that uses air heated by a ceramic heating element for heat and humidification is provided. In this respect, the apparatus includes an air passage disposed therein with the ceramic heating element disposed within the air passage. The air passage includes a partition stationed between the ceramic heating element and a heater outlet that is used to exhaust heated air that flows through the ceramic heating element. A fan within the apparatus is used to attract air from outside of the apparatus into the air passage through an inlet or a vent disposed on the outer surface of the apparatus. The fan then directs the air through the ceramic heating element. Some of the heated air is then diverted by the partition. A portion of the heated air continues to flow within the air passage until the heated air is exhausted from a heater outlet. The remaining heated air is diverted to a cool mist humidifier through an aperture located within the air passage. The heated air is then combined with fine water droplets generated by the humidifier to emit water vapor or mist from a humidifier outlet. A water storage compartment may also be disposed within the apparatus and placed in close proximity to the ceramic heating element and adjacent the air passage. As a result, water supplied to the humidifier is heated without requiring additional energy supplied to the apparatus.

In one embodiment, the portable heater and humidifier apparatus includes a housing comprised of four sidewalls, a top wall, and a bottom wall. Attached to the bottom wall are four castors for increased mobility. The apparatus may also include an inner wall adjacent the sidewalls, the top wall, and the bottom wall of the housing of the apparatus. The inner wall may reduce or prevent thermal conduction of the outer walls of the housing from conducting heat. As a result the outer wall of the housing may be kept near room temperature such that the outer wall does not burn a person who may accidentally or unknowingly touch the apparatus during operation. Preventing the outer surface of the housing from conducting heat may also prevent the ignition of an object nearby. The housing includes an inlet for receiving air from an area to be heated. Disposed within the housing and adjacent the inlet is an ultraviolet (UV) bulb. The UV bulb is used to expose the air entering through the inlet to UV light. The UV light is used to reduce or minimize contaminants such as bacteria in the air entering through the inlet.

The heater and humidifier apparatus also includes a fan used to attract air exterior to the apparatus through the inlet and into the interior of the housing and in particular, the air passage. The fan is disposed within the housing and uses a suction force when operating to direct air through the inlet into the air passage. The ceramic heater disposed within the air passage is located between the fan and the heater outlet. The heater outlet is in fluid communication with the air passage to exhaust heated air into the atmosphere of the area to be heated. The air passing through the ceramic heater passes through slight openings. The heater outlet may be located on a front sidewall of the housing. The heater outlet is an opening that allows the heated air passing through the ceramic heater via the air passage to be exhausted. A portion of the heated air may also be diverted and prevented from being exhausted via the heater outlet. The heated air is diverted using a partition disposed between the ceramic heater and the heater outlet. A portion of the heated air is directed through an aperture within the air passage through a passageway and to the humidifier. The heated air is then mixed with fine droplets of water to generate water vapor that is emitted via a humidifier outlet. The humidifier outlet may also be located at the front sidewall of the housing. Thus, the front sidewall includes two outlets, one for the heated air and a second outlet for the emitted water vapor.

The humidifier of the apparatus is supplied with water from a water storage compartment. A water pump in fluid communication with the water storage compartment is used to pump water into a water basin of the humidifier. As the heated air passes over the water basin of the humidifier, water vapor is generated and entrained within the heated air. Thus, the humidifier outlet may emit water vapor simultaneous to heated air being exhausted from the heater outlet. Additionally, both the heater outlet and the humidifier outlet may be disposed adjacent each other such that the water vapor is emitted adjacent the heated air exhausted by the apparatus. In one embodiment, the air passage defines an air flow axis and the humidifier outlet defines a humidity flow axis. The air flow axis and the humidity flow axis are parallel. The adjacent configuration of the heater outlet and the humidifier outlet increases the efficiency of the apparatus.

The apparatus may also include a control panel. The control panel may be remotely controlled using a remote or controlled at the control panel interface. The control panel may include an on switch, off switch, a display to indicate temperature and humidity levels. The control panel may also include a method to input the desired temperature and humidity level of the area to be heated. Additionally, the control panel may also include a method to input the dimensions of the area to be heated to more accurately and uniformly heat the area.

In more detail, the air passage of the heater and humidifier apparatus includes an upper thermally conductive plate and two lower thermally conductive plates. The upper plate and the lower plates are co-extensive and define a horizontal space along the length of the air passage. The air passage may also include thermal conductive plates made of a material such as copper or any like material with similar properties.

The ceramic heater may be comprised of a plurality of ceramic plates having a positive temperature coefficient (PTC). The plurality of ceramic plates is stackable to form a plurality of ceramic plate layers. The plurality of layers forms the ceramic heater also known as the ceramic heating element which produces infrared energy to heat air passing therethrough.

In another embodiment, the water pump is used to supply the humidifier with water that is stored in the water storage compartment. The water pump and the water storage compartment may be interconnected using a fluid supply line. The water storage compartment may also be refillable and accessible when a removable panel on one of the sidewalls of the housing is removed. The humidifier may also include a fluid level sensor in electrical communication with the water pump. The fluid level sensor is disposed within the water basin of the humidifier. If the fluid level sensor achieves a particular position, an electrical signal may be transmitted to the water pump. The electrical signal may represent low water level or adequate water level within the water basin of the humidifier. Based upon the electrical signal received by the water pump, the supply of water from the water storage compartment is either cut-off or supplied.

In another embodiment, a method for heating and humidifying and area is provided. The method begins with receiving air from the area to be heated through an inlet of a heater and humidifier apparatus. The air flowing through the inlet is directed to an air passage using a fan. The method continues by heating air that passes through a ceramic heater disposed within the air passage. Some of the air passing through the ceramic heater within the air passage is diverted to a humidifier. The heated air is diverted using a partition disposed within the air passage in close proximity to an aperture directing the heated air to the humidifier. The humidifier emits water vapor via a humidifier outlet. The method continues with exhausting heated air from the air passage via a heater outlet. The heated air being exhausted adjacent the water vapor being emitted from the humidifier outlet.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a heater and humidifier apparatus constructed in accordance with the present invention;

FIG. 2 is another perspective view of the heater and humidifier apparatus;

FIG. 3 is a frontal view of a control panel;

FIG. 4 is a cut-away view of the heater and humidifier apparatus; and

FIG. 5 is a partial cut-away view of the heater and humidifier apparatus, depicting the humidifier.

### DETAILED DESCRIPTION

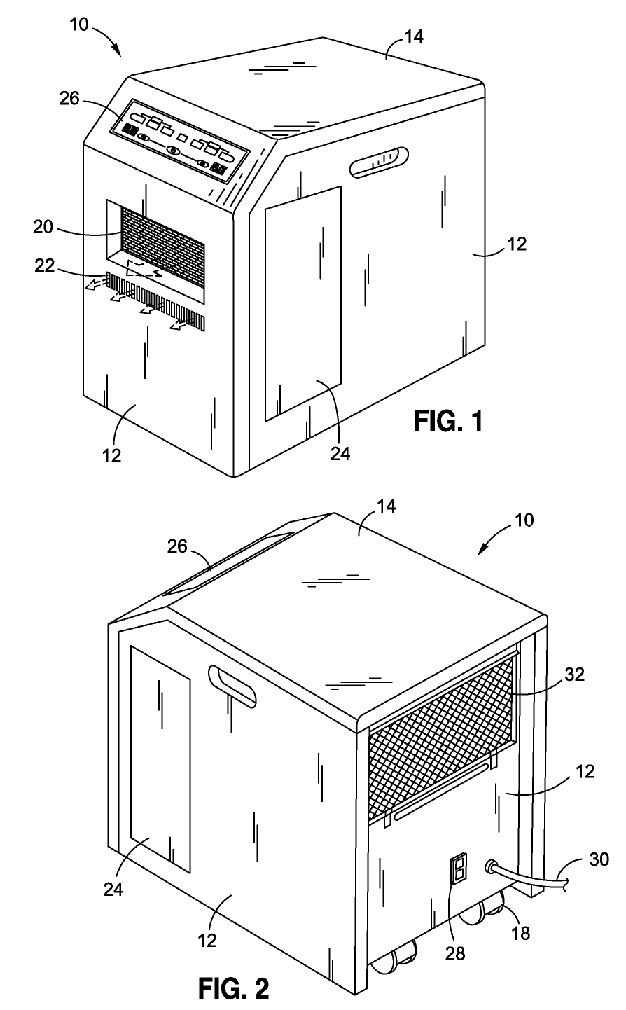

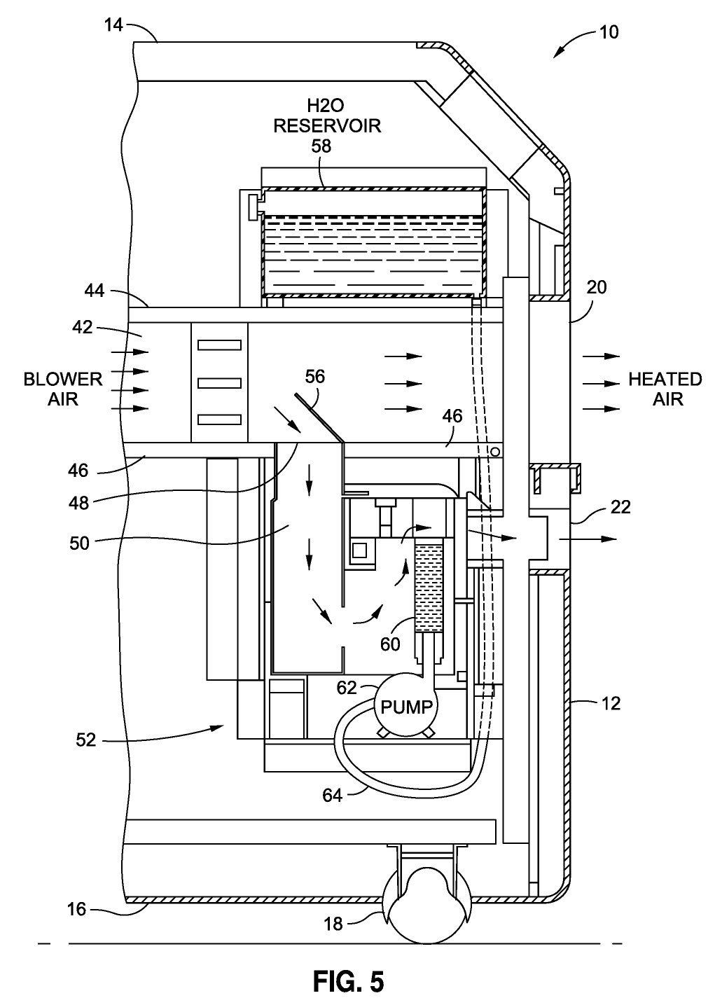

With reference to FIG. 1, a heater and humidifier apparatus 10 is provided. The heater aspect of the apparatus 10 is an electric space heater which uses a ceramic heating element, and is fan-forced. This embodiment distributes heat evenly, and allows the heater to be encased in plastic, wood or like material, thereby minimizing the risks of burns or fire. The apparatus 10 may be a mobile unit such as a rectangular housing that can support the necessary elements for the apparatus 10 to operate. The housing is constructed from four sidewalls 12, a top wall 14, and a bottom wall 16 as provided in FIGS. 4 and 5. Attached to the bottom wall 16 are four castors 18 which enable the rectangular housing to be easily pushed to and from different areas to be heated. As will be recognized, it is not necessary for the housing of the apparatus 10 to be rectangular, and that it can be any shape and size that facilitates the operation of the space heater and humidifier apparatus 10. The front sidewall 12 of the housing includes a heater outlet 20 and a humidifier outlet 22. The heater outlet 20 and the humidifier outlet 22 on the front sidewall 12 may be disposed in an adjacent manner.

The heater outlet 20 exhausts heated air into the area to be heated. The humidifier outlet 22 emits water vapor or mist into the area to be heated. In this regard, both the heated air and the water vapor may be emitted or exhausted from the apparatus 10 in close proximity. Placing the humidifier outlet 22 adjacent the heater outlet 20 on the front sidewall 12 of the housing exposes the heated air to water vapor immediately upon entering the area to be heated. The close proximity of the heater outlet 20 to the humidifier outlet 22 minimizes the “dry” feeling of heated air associated with space heaters. Additionally, the outer surface of the housing may include a control panel 26 for operating and monitoring the apparatus 10. The housing also includes a removable panel 24 disposed within one of the sidewalls 12. The removable panel 24 when removed from the sidewall 12 allows for limited access into the interior of the housing. The above configuration of the apparatus 10 is by way of example only and not of limitation.

Referring now to FIG. 2, the rear sidewall 12 preferably includes a main electrical switch 28. The main electrical switch 28 is used to power on and off the electrical circuits associated with the apparatus 10 under normal load conditions. The rear sidewall 12 of the housing also includes a cable 30. The cable 30 is a conduit for electrical power supply from an outlet or other power source to the apparatus 10. The cable 30 may include a connector (not shown) such as a female or male plug that may be mated with an outlet or another plug corresponding to a power supply source. The rear sidewall 12 also includes an inlet 32. The inlet 32 is configured to receive air from a location exterior to the housing of the apparatus 10. The inlet 32 disposed on the rear sidewall 12 of the apparatus 10 provides an opening for the apparatus 10 to receive air that is to be heated. In one embodiment, the inlet 32 is a vent. The vent may be lattice shaped. Additionally, a washable and removable air filter may be coupled to the vent to prevent particles in the air such as dust, dirt, grime and the like from entering the interior of the housing through the vent.

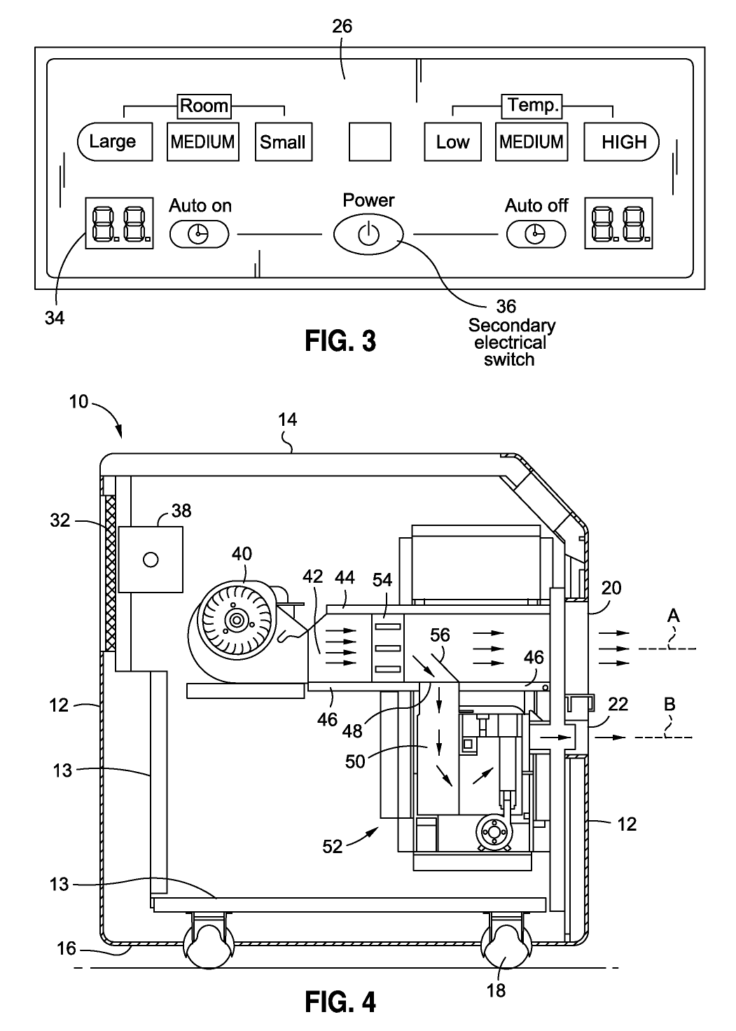

Referring now to FIG. 3, the control panel 26 is provided. The control panel 26 may include displays 34, a power switch 36, energy consumption indicator, low water level indicator, timer and various other controls. Additionally, the control panel 26 may include a dial, a button, or a touch-screen display to configure the settings on the apparatus 10 associated with the area to be heated. The heater and humidifier apparatus 10 may be used in areas of varying sizes such as a living room, a bathroom, or a bedroom for example. Different settings may be required to evenly heat a particular area. Furthermore, there are settings included on the control panel 26 used to manipulate or control the temperature of the area to be heated. In one embodiment, the dimensions of the area to be heated may be entered via the control panel 26. However, the dimensions of the area to be heated may not be necessary, it may suffice to simply indicate whether the area to be heated is a small, medium, or large room. With respect to temperature, a specific temperature may be entered to correspond to the temperature the area is to be heated by the apparatus 10. In one embodiment, humidification settings may be entered via the control panel 26. For example, a percent humidification may be entered. The control panel 26 may be disposed on the surface of one of the sidewalls 12 of the housing. For example, the control panel 26 may be located on the front sidewall 12 above the heater outlet 20 and the humidifier outlet 22. The control panel 26 may also be located on the top wall 14 in a different embodiment. The control panel 26 included may also be controlled via a wireless remote control.

Referring now to FIG. 4, disposed within the housing is an ultraviolet (UV) bulb 38. The UV bulb 38 is positioned adjacent the inlet 32. The UV bulb 38 is coupled to the inlet 32 along the rear sidewall 12 of the housing. The UV bulb 38 is configured to emit UV light. The air passing through the inlet 32 is then exposed to the UV light. The UV light from the UV bulb 38 minimizes bacteria and other contaminants in the air entering the apparatus 10 through the inlet 32. The UV light causes mutation in DNA, which results in bacteria being unable to reproduce properly and dying off after time. As a result, use of the UV bulb 38 to shed UV light on air entering the interior of the housing kills bacteria and purifies the air prior to being heated and then exhausted.

Still referring to FIG. 4, a fan 40 used to attract air from an area exterior to the housing is provided. The fan 40 is used to create a suction force to direct air through the inlet 32 and into the interior of the housing. The air entering through the inlet 32 is exposed to the UV bulb 38 and finally directed to an air passage 42. Air is drawn and received by the fan 40. For example, the fan 40 operates to draw air from an area exterior to the housing through inlet 32 thereby allowing air to flow to the air passage 42. Although a single fan 40 is depicted, those having ordinary skill in the art will recognize that one or more fans may be incorporated. The fan 40 is in fluid communication with the air passage 42. The fan 40 is disposed within the housing between the inlet 32 and the air passage 42. In one embodiment, the fan 40 is attached or coupled to the air passage 42. Air volume drawn in by the fan 40 may be increased or decreased by controlling the number of rotations of a fan motor that drives the fan 40. The number of rotations of the fan motor is controlled by adjusting the applied voltage.

The air passage 42 is a fluid path for facilitating the flow of air from the fan 40 to the heater outlet 20. The air passage 42 is formed by an upper plate 44 and two lower plates 46. The upper plate 44 is uniform and continuous along the entire air passage 42. The two lower plates 46 are parallel to the upper plate 44. Between the two lower plates 46 there exists an aperture 48. The aperture 48 allows air flowing through the air passage 42 into a fluid pathway 50 supplying heated air to the humidifier 52. In one embodiment, the upper plate 44 and the two lower plates 46 are thermally conductive plates. The plates 44, 46 may be made of material such as copper or other material that facilitates thermal conduction.

The ingress of the air passage 42 is proximate the fan 40 such that the flow of air attracted by the fan 40 may then be directed to the air passage 42. The distal end of the air passage 42 is proximate the heater outlet 20 disposed on the front sidewall 12 of the housing. The area comprising the air passage 42 is defined by the upper plate 44 and the two lower plates 46. The upper and lower plates 44, 46 of the air passage 42 define a substantially horizontal fluid path. The fluid path provides for air to flow through a ceramic heating element then exit the heater outlet 20 or humidifier outlet 22 depending upon the direction of the air flow subsequent to passing the ceramic heating element. The air passage 42 is in fluid communication with the heater outlet 20. As a result, heated air flowing through the air passage 42 may be exhausted via the heater outlet 20.

The ceramic heating element is a ceramic heater 54 which produces infrared energy for heating the air flowing through the air passage 42 as provided in FIG. 4. The ceramic heater 54 is disposed within the air passage 42 and configured to span across the height of the air passage 42. In other words, the ceramic heater 54 is disposed within a horizontal opening defined by the upper and lower plates 44, 46 of the air passage 42. The ceramic heater 54 is located between the fan 40 and the heater outlet 20. Additionally, it should be noted that the ceramic heater 54 is disposed within the air passage 42 such that the aperture 48 formed by the two lower plates 46 is positioned between the ceramic heater 54 and the heater outlet 20. This allows for the aperture 48 to receive heated air after flowing through the ceramic heater 54.

The ceramic heater 54 uses materials that have a positive temperature coefficient (PTC). As the temperature of the ceramic heater 54 rises, the resistance increases, reducing the current flow and thereby protecting electrical equipment vulnerable to increased current flow. As such the PTC ceramic heating element works as its own thermostat, switching off the supply of current when reaching a maximum temperature.

In one embodiment, barium titanate ceramic with additives is used as the PTC material comprising the ceramic heater 54. The use of barium titanate ceramic results in rapid increase of electrical resistance near Curie temperature. As a result, the current flow slows due to the self-heating, or Joule heat, when the current is kept flowing. Thus, constant temperature can be kept and the apparatus 10 can be used as a non-polluting heater. Furthermore, the apparatus 10 is equipped with a thermostat (not shown) that prevents drastic rise in temperature inside the housing as a safety precaution. The thermostat may be located on the inside of the housing. A safety shutoff device may also be included (not shown), that automatically shuts power down when the apparatus 10 is tipped or knocked over or not in an upright position.

The specific structure of the ceramic heater 54, includes ceramic material that is processed into plates. The plates are then piled or stacked against each other to form a plurality of layers. Three electrode-connecting terminals (not shown) of insertion-type plugs conduct the current into the plurality of ceramic plates at one end of the layered plates. An air blower mechanism may also be included with the ceramic heater 54. For example, an electrical transformer may be disposed within the apparatus 10. The transformer provides two ceramic heaters 54 with a 180 degree phase shifting wavelength waveform electricity. The electrical transformer controls the current flow rate. The heat generated in the ceramic heater 54 is sent out by operation of the fan 40 as heated air via the heater outlet 20. The control of the current flow rate by the supply of waveform electricity is one example and it goes without saying that other types of current flow rate controls may be used. Thus, by controlling the current flow rate at the ceramic heater 54, and by keeping the constant volume of air flow, it is possible to control electrical energy to the ceramic heater 54.

A current is provided to the ceramic heater 54 utilizing PTC material for increased resistance. The current is provided via the electrode connecting terminals. As a result, the ceramic heater 54 may quickly increase in temperature from the current supply. The electrode connecting terminals deliver power to the ceramic heater 54. The ceramic heater's 54 temperature is dependent upon the electricity flow supplied by the electrode connecting terminals. Thus, heat is generated by controlling the electricity flow rate by supplying half-wavelength waveform electricity. The air is heated as it flows through the ceramic heater 54. Then the heated air continues flowing through the air passage 42 toward the heated air outlet 20. It is important to note that the flow of air from the inlet 32 through the ceramic heater 54 and onward to the heated air outlet 20 is caused by the rotation of the fan 40. The air now warm is sent out into the area to be heated from the heated air outlet 20. Furthermore, a portion of the heated air flowing through the air passage 42 is diverted using the partition 56. The partition 56 directs the heated air through the aperture 48 then through the fluid pathway 50 to the humidifier 52. The heated air diverted to the humidifier 52 is combined with moisture provided by the humidifier 52 to emit water vapor from the humidifier outlet 22.

The ceramic heater 54 is used to heat the air that flows through the air passage 42 in the direction of the heater outlet 20. Upon entering the air passage 42, the air is not heated until it passes through the ceramic heater 54. In this respect, the plurality of ceramic plates that comprise the ceramic heater 54 include openings wherein the air flows through. As a result, after the air flows through the ceramic heater 54 it is heated and ready to be exhausted via the heater outlet 20 as heated air. Additionally, the thermally conductive upper plate 44 and the lower plates 46 prevent or minimize the heat loss in the air after it passes through the ceramic heater 54, but prior to being exhausted via the heater outlet 20. However, not all the air flowing through the ceramic heater 54 within the air passage 42 is exhausted via the heater outlet 20.

Also disposed within the air passage 42 is the partition 56 which is used to divert a portion of the heated air flowing through the ceramic heater 54 to the humidifier 52. The partition 56 may be coupled or attached to one of the lower plates 46 and is configured to extend towards the ceramic heater 54. The partition 56 is disposed within the air passage 42 to direct heated air from the ceramic heater 50 through the aperture 48. For example, the heated air flowing through the ceramic heater 54 advances through the air passage 42 and contacts the partition 56. The partition 56 then diverts the heated air into the fluid passageway 50 through the aperture 48 to the humidifier 52. The combination of the air flow provided by the fan 40 and the positioning of the partition 56 facilitate the diversion of some of the heated air flowing through the air passage 42. Simultaneous to the heated air being diverted by the partition 56, the heated air flowing within the air passage 42 above the partition 56 is exhausted via the heater outlet 20.

In one embodiment, the air passage 42 defines an air flow axis A. The humidifier outlet 22 defines a water vapor axis B. The air flow axis A and the water vapor axis are parallel and adjacent to each other. The proximity is preferred because of the interaction of the water vapor with the ‘dry’ or heated air exhausted from the heater outlet 20.

In another embodiment, the partition 56 is adjustable. In this respect the heated air supplied to the humidifier 52 may be controlled by the positioning of the partition 56. If the humidifier 52 is turned off at the control panel 26, the partition 56 is used to block the aperture 48 and prevent heated air from entering the fluid path 50. If this occurs, all the heated air flowing through the air passage 42 is exhausted via the heater outlet 20. Therefore, the adjustable partition 56 may be used to vary the supply of heated air to the humidifier 52. The partition 56 may be in electrical communication with the control panel 26. In this regard, the position of the partition 56 may be specified at the control panel 26.

Referring now to FIG. 5, the humidifier 52 is provided. The humidifier 52 includes a water storage compartment 58 for storing water within the housing. The water storage compartment 58 supplies water to a water basin 60 disposed within the humidifier 52. In one embodiment, the humidifier 52 may include a wicking filter to absorb the water from the water basin 60. A fan disposed within the humidifier 52 blows air through a moistened filter. As the heated air passes through the moistened filter, it evaporates some of the water there. However, a drawback associated with cool-mist humidifiers is that the cool water can be a breeding ground for mold and bacteria. Additionally, cool-mist humidifiers are quite efficient at dispersing the minerals within tap water which may cause health problems for persons with heightened sensitivities to the minerals. Therefore, using the heated air that passes through the ceramic heater 54 to mix with the water supplied to the humidifier 52 reduces the dispersion of minerals and bacteria within the water. As a result, the minerals and microorganisms may be reduced and thus minimize the bacterial levels.

The humidifier 52 is configured to receive water stored in the water storage compartment 58. In one embodiment, the water storage compartment 58 is a refillable container. The container may be removed from the housing and refilled when the water level is low. For example, the removable panel 24 located on the sidewall 12 may be removed to provide access to the water storage compartment 58. The control panel 26 may include an indicator light or display that warns when the water level within the water storage compartment 58 is low and needs to be refilled.

As shown in FIG. 5, the water storage compartment 58 may be positioned adjacent the air passage 42. When the water reservoir 58 is adjacent the air passage 42 and consequently near the ceramic heater 54 the water stored within the water storage compartment 58 may be heated without requiring additional energy. Heating the water within the water reservoir 58 may result in reducing the bacteria and microorganism count. In another embodiment, the water storage compartment 58 may also be positioned within the housing away from the air passage 42 and the ceramic heater 54, possibly in an area below the fan 40 if heat emitted from the air passage 42 and ceramic heater 54 are not desired.

The water storage compartment 58 is connected to a water pump 62 via a fluid supply line 64. The fluid supply line 64 may be a pipe made of metal, plastic, and like material suitable for the interior of the housing. The humidifier 52 is disposed within the housing below the air passage 42. The humidifier 52 is located near the front sidewall 12 in close proximity to the humidifier outlet 22. The humidifier 52 is in fluid communication with the fluid path 50 where heated air flowing through the air passage 42 is diverted by the partition 56. As a result, the heated air from the air passage 42 is directed to the moisture provided by the water basin 60 of the humidifier 52 to generate and entrain water vapor. The water vapor and heater air are then emitted from the humidifier outlet 22.

The water basin 60 of the humidifier 52 may also include a sensor control float (not shown). The sensor control float may be in electrical communication with the water pump 62. The sensor control float is configured to generate an electrical signal that is transmitted to the water pump 62 to open or close a valve in order to supply or cut-off water. For example, when the water level within the water basin 60 is low, the sensor control float may transmit an electrical signal causing the valve associated with the water pump 62 to open and supply water to the water basin 60 from the water storage compartment 58 via the fluid supply line 64. The water basin 60 may receive water continuously until the sensor control float transmits an electrical signal to the water pump 62 instructing the water valve to close. Other devices and methods may be used to determine the water level in the water basin 60.

Referring back to FIG. 4, the heater and humidifier apparatus 10 may include a double-layered structure as illustrated. The four sidewalls 12, top wall 14, and bottom wall 16 of the housing may comprise the outer plate of the apparatus 10. The outer plate may be constructed from materials such as wood, plastic, and the like. The examples of materials used for the outer plate are by way of example only and not of limitation. Additionally, an inner wall plate divider 13 is provided adjacent to the inner portion of the rear sidewall 12. There exists an arbitrary amount of space between the rear sidewall 12 and the adjacent inner wall plate divider 13. The inner wall plate divider 13 may prevent or minimize the conduction of heat by the sidewalls 12, top wall 14 and bottom wall 16.

The apparatus 10 is moved to a desired position in a room or an area to be heated using the casters 18. Next, the main electrical switch 28 located on the rear sidewall 12 below the inlet 32 of the apparatus 10 is switched to the on position. The various parameters are then set, which may include the volume of air, temperature, timer, etc., using the control panel 26. A secondary electrical switch 36 is turned on via the control panel 26. The secondary electrical switch 36 allows for an electrical signal to turn the fan motor on. As the fan motor turns on, the fan 40 starts to rotate. Air is then received through the inlet 32 and continues to flow through to the air passage 42. Furthermore, the secondary electrical switch 36 may also control the humidifier 52 of the apparatus 10. When the humidifier 52 is operating, water from the water storage compartment 58 is directed to the water pump 62 via the fluid supply line 64. The water pump 62 then supplies the water basin 60 of the humidifier 52 with water. Fine droplets are generated that combine with the heated air diverted from the air passage 42 to form mist or water vapor that is emitted from the humidifier outlet 22.

To maintain the temperature of the heated air within the air passage 42, the upper plate 44 and the lower plates 46 are thermal conductive plates made of copper. Using copper plating for the upper and lower plates 44, 46 that define the air passage 42 improves thermal conduction. The copper is provided on the inside wall of the air passage 42. The copper plates extend along the entirety of the air passage 42. As a result, the heated air flowing from the ceramic heater 54 is not cooled as it flows through the air passage 42 and out of the heated air outlet 20. Additionally, because the thermal conductive plates are made of copper (plate), the air heated by the ceramic heater 54 contacts the copper plates, enabling the generation of far-infrared radiation. Therefore, radiant heat emitted due to the far-infrared radiation effect, warms the area to be heated uniformly. Also, since the humidifier 52 generates vapor, the humidity level in the room during operation of apparatus 10 is increased. Further, the water vapor helps increase air temperature of the area to be heated. In another embodiment, the thermal conductive plates are made from a material with thermal conductivity characteristics similar to copper.

The above description is given by way of example, and not limitation. Given the above disclosure, one skilled in the art could devise variations that are within the scope and spirit of the invention disclosed herein, including various ways of embodying a portable generator with a detachable control panel. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A portable heater and humidifier apparatus, comprising:
a housing having an inlet for receiving air into the housing;
an air passage disposed within the housing, the air passage defining an air flow axis;
a fan disposed within the housing between the inlet and the air passage, the fan being in fluid communication with the air passage, the fan being configured to direct air flowing through the inlet to the air passage;
a heater outlet in fluid communication with the air passage, the heater outlet configured to exhaust heated air flowing through the air passage;
a ceramic heater disposed within the air passage between the fan and the heater outlet;
a partition disposed within the air passage between the ceramic heater and the heater outlet, the partition being configured to divert a portion of the heated air flowing along the air flow axis to a humidifier;
a humidifier outlet in fluid communication with the humidifier, the humidifier outlet defining a humidity flow axis parallel to the air flow axis, the humidifier outlet configured to exhaust water vapor from the humidifier.

2. The apparatus of claim 1, wherein the inlet is a vent.

3. The apparatus of claim 1, wherein the air passage is comprised of a plurality of thermal conductive plates.

4. The apparatus of claim 3, wherein the thermal conductive plates are made of copper.

5. The apparatus of claim 1, wherein the ceramic heater is comprised of a plurality of ceramic plates having a positive temperature coefficient, the plurality of ceramic plates being stackable to form a plurality of ceramic plate layers.

6. The apparatus of claim 1, further comprising an ultraviolet bulb disposed within the housing adjacent the inlet.

7. The apparatus of claim 1, further comprising:
a water storage compartment; and
a water pump in fluid communication with the water storage compartment, the water pump in fluid communication with the humidifier, the water pump receiving water from the water storage compartment via a fluid supply line, the water pump being configured to supply the humidifier with water.

8. The apparatus of claim 7, wherein the water storage compartment is a refillable bottle.

9. The apparatus of claim 1, wherein the humidifier system includes a fluid level sensor.

10. The apparatus of claim 1, wherein a multi-layered structure of outer and inner plates are constructed to prevent a surface of the apparatus from conducting heat.

11. The apparatus of claim 1, wherein the water vapor emitted by the humidifier outlet is emitted simultaneously with the heated air exhausted via the heater outlet.

12. The apparatus of claim 1, wherein the water vapor emitted by the humidifier outlet is emitted adjacent the heated air exhausted via the heater outlet.

13. A method for heating and humidifying an area, the method comprising:
receiving air from the area to be heated through an inlet of a heater and humidifier apparatus;
guiding air via the inlet into an air passage using a fan;
heating air flowing through the air passage using a ceramic heater;
diverting a portion of the heated air from the air passage to a humidifier;
emitting water vapor via a humidifier outlet; and
exhausting heated air from the air passage via a heater outlet, the heated air being exhausted adjacent the water vapor being emitted from the humidifier outlet.

14. The method of claim 13, wherein the inlet is a vent.

15. The method of claim 13, wherein the air passage is comprised of a plurality of thermally conductive plates.

16. The method of claim 13, wherein the ceramic heater includes a plurality of ceramic plates having a positive temperature coefficient, the plurality of ceramic plates are stackable to form a plurality of ceramic plate layers.

17. The method of claim 13, further comprising:
supplying the humidifier with water via a water pump, the water pump receiving the water from a water storage compartment via a fluid supply line.

18. The method of claim 17, wherein the water storage compartment is a refillable bottle.

19. The method of claim 17, further comprising:
a fluid level sensor in electrical communication with the water pump, the fluid level sensor configured to control the supply of water to the humidifier via an electrical signal transmitted to the water pump.

20. The method of claim 13, wherein the humidifier emits water vapor via a humidifier outlet into the area to be heated as the heated air is exhausted via the heater outlet.
